(19) United States
(12) Patent Application Publication
(10) Pub. No.: US 2019/0387040 A1
(43) Pub. Date: Dec. 19, 2019

(54) LEVEL ESTIMATION FOR PROCESSING AUDIO DATA

(71) Applicant: QUALCOMM Incorporated, San Diego, CA (US)

(72) Inventors: Richard Turner, Belfast (GB); Laurent Wojcieszak, Belfast (GB); Justin Hundt, Londonderry (GB); Gary Sands, Belfast (GB); Derrick Rea, Broughshane (GB)

(21) Appl. No.: 16/295,813

(22) Filed: Mar. 7, 2019

Related U.S. Application Data
(60) Provisional application No. 62/686,616, filed on Jun. 18, 2018.

(51) Int. Cl. H04L 29/06; G10L 19/002; G10L 19/032; H04W 4/80

(52) U.S. Cl. CPC H04L 65/602; H04L 65/607; H04W 4/80; G10L 19/032; H04L 69/04; G10L 19/002

(57) ABSTRACT

In general, techniques are described that enable a source device to perform level estimation for processing audio data. The source device may include a memory and a processor. The memory may store at least a portion of the audio data. The processor may obtain a current indication representative of a current level of a current block of the audio data, and obtain a previous indication representative of a previous level of a previous block of the audio data. The processor may perform, based on the current indication and the previous indication, level estimation to obtain a level estimate indication representative of an estimate of the level of the current block of the audio data. The processor may also perform, based on the level estimate indication, compression with respect to the current block of the audio data to obtain a bitstream.

This application claims the benefit of U.S. Provisional Application No. 62/686,616, entitled “LEVEL ESTIMATION FOR PROCESSING AUDIO DATA,” and filed 18 Jun. 2018, the entire contents of which are incorporated herein by reference.

### TECHNICAL FIELD

This disclosure relates to processing audio data and, more specifically, level estimation when compressing and decompressing audio data.

### BACKGROUND

Wireless networks for short-range communication, which may be referred to as “personal area networks,” are established to facilitate communication between a source device and a sink device. One example of a personal area network (PAN) protocol is Bluetooth®, which is often used to form a PAN for streaming audio data from the source device (e.g., a mobile phone) to the sink device (e.g., headphones or a speaker).

The source device may include an audio encoder by which to compress the audio data prior to transmission as a bitstream via the PAN. During compression, the audio encoder may perform level estimation to obtain a quantization step size. When performing level estimation, the audio encoder may predict current audio levels (e.g., gain) based on past audio levels. The audio encoder may quantize the audio data using the quantization step size to reduce a number of bits used to represent the audio data in the bitstream.

Likewise, the sink device may include an audio decoder by which to decompress the bitstream received via the PAN to obtain a decompressed version of the audio data. The audio decoder may also perform level estimation to obtain the quantization step size, which may be used during inverse dequantization to obtain the decompressed version of the audio data.

Level estimation may, however, not be suitable for audio data that includes rapidly fluctuating levels, which is present, as one example, in music featuring drums or other loud percussion instruments, electronic dance music (EDM), etc, as level estimation may be unable to predict the occurrence of the rapidly fluctuating levels based on previous audio levels. The result of level estimation in the context of audio data including rapidly fluctuating levels may result in dampening of levels, as the quantization step size is not large enough to allow the audio encoder sufficient dynamic range to represent the rapidly fluctuating levels.

### SUMMARY

In general, techniques are described by which to perform level estimation when processing audio data in a manner that may reduce dampening of audio data that includes rapidly fluctuating levels. The techniques may enable an audio encoder and an audio decoder to obtain an indication of a current level of a current block of audio data. As such, the audio encoder and the audio decoder may perform level estimation relative to a current level of the current block of the audio data and thereby increase a quantization step size or other metric relevant to dynamic range so as to reduce dampening of rapidly fluctuating levels in the audio data.

In this respect, the techniques may enable the audio encoder and the audio decoder to improve operation of the source device and the sink device themselves in terms of better compressing the audio data in a manner that potentially avoids injecting audio artifacts. The techniques may allow the audio encoder and the audio decoder to better represent the audio data (compared to level estimation based only on levels of previous blocks of audio data) without increasing a number of bits used to represent the audio data in the bitstream. That is, the techniques may allow the audio encoder and the audio decoder to improve signal to noise ratios without increasing the number of bits allocated to the current block, which improves the operation of the audio encoder and the audio decoder themselves in contrast to merely implementing a known process using devices.

In one aspect, the techniques are directed to a source device configured to process audio data, the source device comprising: a memory configured to store at least a portion of the audio data; and one or more processors coupled to the memory, and configured to: obtain a current indication representative of a current level of a current block of the audio data; obtain a previous indication representative of a previous level of a previous block of the audio data; perform, based on the current indication and the previous indication, level estimation to obtain a level estimate indication representative of an estimate of the level of the current block of the audio data; and perform, based on the level estimate indication, compression with respect to the current block of the audio data to obtain a bitstream.

In another aspect, the techniques are directed to a method of processing audio data, the method comprising: obtaining a current indication representative of a current level of a current block of the audio data; obtaining a previous indication representative of a previous level of a previous block of the audio data; performing, based on the current indication and the previous indication, level estimation to obtain a level estimate indication representative of an estimate of the level of the current block of the audio data; and performing, based on the level estimate indication, compression with respect to the current block of the audio data to obtain a bitstream.

In another aspect, the techniques are directed to a source device configured to process audio data, the source device comprising: means for obtaining a current indication representative of a current level of a current block of the audio data; means for obtaining a previous indication representative of a previous level of a previous block of the audio data; means for performing, based on the current indication and the previous indication, level estimation to obtain a level estimate indication representative of an estimate of the level of the current block of the audio data; and means for performing, based on the level estimate indication, compression with respect to the current block of the audio data to obtain a bitstream.

In another aspect, the techniques are directed to a computer-readable medium having stored thereon instructions that, when executed, cause one or more processors of a source device to: obtain a current indication representative of a current level of a current block of audio data; obtain a previous indication representative of a previous level of a previous block of the audio data; perform, based on the current indication and the previous indication, level estimation to obtain a level estimate indication representative of an estimate of the level of the current block of the audio data; and perform, based on the level estimate indication, compression with respect to the current block of the audio data to obtain a bitstream.

In another aspect, the techniques are directed to a sink device configured to process a bitstream representative of audio data, the sink device comprising: a memory configured to store at least a portion of the bitstream; and one or more processors coupled to the memory, and configured to: obtain, from the bitstream, a current indication representative of a current level of a current block of the audio data represented by the bitstream; obtain a previous indication representative of a previous level of a previous block of the audio data represented by the bitstream; perform, based on the current indication and the previous indication, level estimation to obtain a level estimate indication representative of an estimate of the level of the current block of the audio data represented by the bitstream; and perform, based on the level estimate indication, decompression with respect to the current block of the audio data represented by the bitstream to obtain a decompressed version of the current block of the audio data.

In another aspect, the techniques are directed to a method of processing a bitstream representative of audio data, the method comprising: obtaining, from the bitstream, a current indication representative of a current level of a current block of the audio data represented by the bitstream; obtaining a previous indication representative of a previous level of a previous block of the audio data represented by the bitstream; performing, based on the current indication and the previous indication, level estimation to obtain a level estimate indication representative of an estimate of the level of the current block of the audio data represented by the bitstream; and performing, based on the level estimate indication, decompression with respect to the current block of the audio data represented by the bitstream to obtain a decompressed version of the current block of the audio data.

In another aspect, the techniques are directed to a sink device configured to process a bitstream representative of audio data, the sink device comprising: means for obtaining, from the bitstream, a current indication representative of a current level of a current block of the audio data represented by the bitstream; means for obtaining a previous indication representative of a previous level of a previous block of the audio data represented by the bitstream; means for performing, based on the current indication and the previous indication, level estimation to obtain a level estimate indication representative of an estimate of the level of the current block of the audio data represented by the bitstream; and means for performing, based on the level estimate indication, decompression with respect to the current block of the audio data represented by the bitstream to obtain a decompressed version of the current block of the audio data.

In another aspect, the techniques are directed to a non-transitory computer-readable storage medium having stored thereon instructions that, when executed, cause one or more processors of a sink device to: obtain, from a bitstream representative of audio data, a current indication representative of a current level of a current block of the audio data represented by the bitstream; obtain a previous indication representative of a previous level of a previous block of the audio data represented by the bitstream; perform, based on the current indication and the previous indication, level estimation to obtain a level estimate indication representative of an estimate of the level of the current block of the audio data represented by the bitstream; and perform, based on the level estimate indication, decompression with respect to the current block of the audio data represented by the bitstream to obtain a decompressed version of the current block of the audio data.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a block diagram illustrating a system that may perform various aspects of the techniques described in this disclosure.

FIG. 2 is a block diagram illustrating an example of the audio encoder of FIG. 1 in performing various aspects of the techniques described in this disclosure.

FIG. 3 is a block diagram illustrating an example of the audio decoder of FIG. 1 in performing various aspects of the techniques described in this disclosure.

FIG. 4 is a block diagram illustrating an example of the level estimation unit shown in FIGS. 2 and 3 in more detail.

FIG. 5 is a flowchart illustrating example operation of the source device of FIG. 1 in performing various aspects of the techniques described in this disclosure.

FIG. 6 is a flowchart illustrating example operation of the sink device of FIG. 1 in performing various aspects of the techniques described in this disclosure.

FIG. 7 is a block diagram illustrating example components of the source device shown in the example of FIG. 1.

FIG. 8 is a block diagram illustrating exemplary components of the sink device shown in the example of FIG. 1.

FIG. 9 is a diagram illustrating a graph 900 in which the level estimation unit shown in the example of FIG. 4 may increase the quantization step size responsive to an increase in a value of the bit allocation.

FIG. 10 is a diagram illustrating graphs depicting how the level estimation unit shown in the example of FIG. 4 may reduce dampening during rapid levels changes.

FIG. 11 is a diagram illustrating a graph of example audio data that includes rapid level changes, where the Y-axis denotes decibels and the X-axis denotes time.

### DETAILED DESCRIPTION

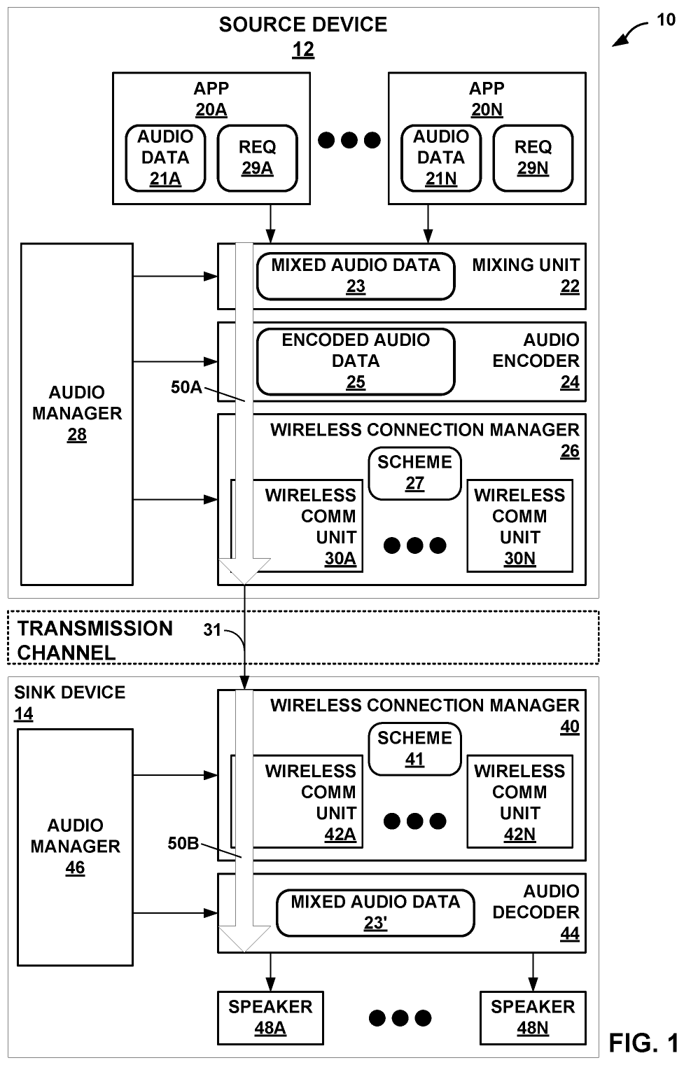

FIG. 1 is a diagram illustrating a system 10 that may perform various aspects of the techniques described in this disclosure. As shown in the example of FIG. 1, the system 10 includes a source device 12 and a sink device 14. Although described with respect to the source device 12 and the sink device 14, the source device 12 may operate, in some instances, as the sink device, and the sink device 14 may, in these and other instances, operate as the source device. As such, the example of system 10 shown in FIG. 1 is merely one example illustrative of various aspects of the techniques described in this disclosure.

In any event, the source device 12 may represent any form of computing device capable of implementing the techniques described in this disclosure, including a handset (or cellular phone), a tablet computer, a so-called smart phone, a remotely piloted aircraft (such as a so-called “drone”), a robot, a desktop computer, a receiver (such as an audio/visual—AV—receiver), a set-top box, a television (including so-called “smart televisions”), a media player (such as s digital video disc player, a streaming media player, a Blue-Ray Disc™ player, etc.), or any other device capable of communicating audio data wirelessly to a sink device via a personal area network (PAN). For purposes of illustration, the source device 12 is assumed to represent a smart phone.

The sink device 14 may represent any form of computing device capable of implementing the techniques described in this disclosure, including a handset (or cellular phone), a tablet computer, a smart phone, a desktop computer, a wireless headset (which may include wireless headphones that include or exclude a microphone, and so-called smart wireless headphones that include additional functionality such as fitness monitoring, on-board music storage and/or playback, dedicated cellular capabilities, etc.), a wireless speaker (including a so-called “smart speaker”), a watch (including so-called “smart watches”), or any other device capable of reproducing a soundfield based on audio data communicated wirelessly via the PAN. Also for purposes of illustration, the sink device 14 is assumed to represent wireless headphones.

As shown in the example of FIG. 1, the source device 12 includes one or more applications (“apps”) 20A-20N (“apps 20”), a mixing unit 22, an audio encoder 24, a wireless connection manager 26, and an audio manager 28. Although not shown in the example of FIG. 1, the source device 12 may include a number of other elements that support operation of apps 20, including an operating system, various hardware and/or software interfaces (such as user interfaces, including graphical user interfaces), one or more processors, memory, storage devices, and the like.

Each of the apps 20 represent software (such as a collection of instructions stored to a non-transitory computer readable media) that configure the source device 10 to provide some functionality when executed by the one or more processors of the source device 12. Apps 20 may, to provide a few examples, provide messaging functionality (such as access to emails, text messaging, and/or video messaging), voice calling functionality, video conferencing functionality, calendar functionality, audio streaming functionality, direction functionality, mapping functionality, gaming functionality. Apps 20 may be first-party applications designed and developed by the same company that designs and sells the operating system executed by the source device 20 (and often pre-installed on the source device 20) or third-party applications accessible via a so-called “app store” or possibly pre-installed on the source device 20. Each of the apps 20, when executed, may output audio data 21A-21N (“audio data 21”), respectively.

The mixing unit 22 represent a unit configured to mix one or more of audio data 21A-21N (“audio data 21”) output by the apps 20 (and other audio data output by the operating system—such as alerts or other tones, including keyboard press tones, ringtones, etc.) to generate mixed audio data 23. Audio mixing may refer to a process whereby multiple sounds (as set forth in the audio data 21) are combined into one or more channels. During mixing, the mixing unit 22 may also manipulate and/or enhance volume levels (which may also be referred to as “gain levels”), frequency content, and/or panoramic position of the audio data 21. In the context of streaming the audio data 21 over a wireless PAN session, the mixing unit 22 may output the mixed audio data 23 to the audio encoder 24.

The audio encoder 24 may represent a unit configured to encode the mixed audio data 23 and thereby obtain encoded audio data 25. Referring for purposes of illustration to one example of the PAN protocols, Bluetooth® provides for a number of different types of audio codecs (which is a word resulting from combining the words “encoding” and “decoding”), and is extensible to include vendor specific audio codecs. The Advanced Audio Distribution Profile (A2DP) of Bluetooth® indicates that support for A2DP requires supporting a subband codec specified in A2DP. A2DP also supports codecs set forth in MPEG-1 Part 3 (MP2), MPEG-2 Part 3 (MP3), MPEG-2 Part 7 (advanced audio coding—AAC), MPEG-4 Part 3 (high efficiency-AAC—HE-AAC), and Adaptive Transform Acoustic Coding (ATRAC). Furthermore, as noted above, A2DP of Bluetooth® supports vendor specific codecs, such as aptX™ and various other versions of aptX (e.g., enhanced aptX-E—aptX, aptX live, and aptX high definition—aptX-HD).

AptX may refer to an audio encoding and decoding (which may be referred to generally as a “codec”) scheme by which to compress and decompress audio data, and may therefore be referred to as an “aptX audio codec.” AptX may improve the functionality of the source and sink devices themselves as compression results in data structures that organize data in a manner that reduces bandwidth (including over internal busses and memory pathways) and/or storage consumption. The techniques described in this disclosure may further improve bandwidth and/or storage consumption, thereby improving operation of the devices themselves in contrast to merely implementing a known process using devices.

The audio encoder 24 may operate consistent with one or more of any of the above listed audio codecs, as well as, audio codecs not listed above, but that operate to encode the mixed audio data 23 to obtain the encoded audio data 25. The audio encoder 24 may output the encoded audio data 25 to one of the wireless communication units 30 (e.g., the wireless communication unit 30A) managed by the wireless connection manager 26.

The wireless connection manager 26 may represent a unit configured to allocate bandwidth within certain frequencies of the available spectrum to the different ones of the wireless communication units 30. For example, the Bluetooth® communication protocols operate over within the 2.4 GHz range of the spectrum, which overlaps with the range of the spectrum used by various WLAN communication protocols. The wireless connection manager 26 may allocate some portion of the bandwidth during a given time to the Bluetooth® protocol and different portions of the bandwidth during a different time to the overlapping WLAN protocols. The allocation of bandwidth and other is defined by a scheme 27. The wireless connection manager 26 may expose various application programmer interfaces (APIs) by which to adjust the allocation of bandwidth and other aspects of the communication protocols so as to achieve a specified quality of service (QoS). That is, the wireless connection manager 26 may provide the API to adjust the scheme 27 by which to control operation of the wireless communication units 30 to achieve the specified QoS.

In other words, the wireless connection manager 26 may manage coexistence of multiple wireless communication units 30 that operate within the same spectrum, such as certain WLAN communication protocols and some PAN protocols as discussed above. The wireless connection manager 26 may include a coexistence scheme 27 (shown in FIG. 1 as “scheme 27”) that indicates when (e.g., an interval) and how many packets each of the wireless communication units 30 may send, the size of the packets sent, and the like.

The wireless communication units 30 may each represent a wireless communication unit 30 that operates in accordance with one or more communication protocols to communicate encoded audio data 25 via a transmission channel to the sink device 14. In the example of FIG. 1, the wireless communication unit 30A is assumed for purposes of illustration to operate in accordance with the Bluetooth® suite of communication protocols. It is further assumed that the wireless communication unit 30A operates in accordance with A2DP to establish a PAN link (over the transmission channel) to allow for delivery of the encoded audio data 25 from the source device 12 to the sink device 14.

More information concerning the Bluetooth® suite of communication protocols can be found in a document entitled “Bluetooth Core Specification v 5.0,” published Dec. 6, 2016, and available at: www.bluetooth.org/en-us/specification/adopted-specifications. The foregoing Bluetooth Core Specification provides further details regarding a so-called Bluetooth Low Energy and Classic Bluetooth, where the Bluetooth Low Energy (BLE) operates using less energy than Classic Bluetooth. Reference to Bluetooth® (which may also be referred to as a “Bluetooth® wireless communication protocol”) may refer to one of BLE and Classic Bluetooth, or both BLE and Classic Bluetooth. More information concerning A2DP can be found in a document entitled “Advanced Audio Distribution Profile Specification,” version 1.3.1, published on Jul. 14, 2015.

The wireless communication unit 30A may output the encoded audio data 25 as a bitstream 31 to the sink device 14 via a transmission channel, which may be a wired or wireless channel, a data storage device, or the like. While shown in FIG. 1 as being directly transmitted to the sink device 14, the source device 12 may output the bitstream 31 to an intermediate device positioned between the source device 12 and the sink device 14. The intermediate device may store the bitstream 31 for later delivery to the sink device 14, which may request the bitstream 31. The intermediate device may comprise a file server, a web server, a desktop computer, a laptop computer, a tablet computer, a mobile phone, a smart phone, or any other device capable of storing the bitstream 31 for later retrieval by an audio decoder. This intermediate device may reside in a content delivery network capable of streaming the bitstream 31 (and possibly in conjunction with transmitting a corresponding video data bitstream) to subscribers, such as the sink device 14, requesting the bitstream 31.

Alternatively, the source device 12 may store the bitstream 31 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to those channels by which content stored to these mediums are transmitted (and may include retail stores and other store-based delivery mechanism). In any event, the techniques of this disclosure should not therefore be limited in this respect to the example of FIG. 1.

As further shown in the example of FIG. 1, the sink device 14 includes a wireless connection manager 40 that manages one or more of wireless communication units 42A-42N (“wireless communication units 42”) according to a scheme 41, an audio decoder 44, and one or more speakers 48A-48N (“speakers 48”). The wireless connection manager 40 may operate in a manner similar to that described above with respect to the wireless connection manager 26, exposing an API to adjust scheme 41 by which the wireless communication units 42 operate to achieve a specified QoS.

The wireless communication units 42 may be similar in operation to the wireless communication units 30, except that the wireless communication units 42 operate reciprocally to the wireless communication units 30 to decapsulate the encoded audio data 25. One of the wireless communication units 42 (e.g., the wireless communication unit 42A) is assumed to operate in accordance with the Bluetooth® suite of communication protocols and reciprocal to the wireless communication protocol 28A. The wireless communication unit 42A may output the encoded audio data 25 to the audio decoder 44.

The audio decoder 44 may operate in a manner that is reciprocal to the audio decoder 24. The audio decoder 44 may operate consistent with one or more of any of the above listed audio codecs, as well as, audio codecs not listed above, but that operate to decode the encoded audio data 25 to obtain mixed audio data 23′. The prime designation with respect to “mixed audio data 23” denotes that there may be some loss due to quantization or other lossy operations that occur during encoding by the audio encoder 24. The audio decoder 44 may output the mixed audio data 23′ to one or more of the speakers 48.

Each of the speakers 48 may represent a transducer configured to reproduce a soundfield from the mixed audio data 23′. The transducer may be integrated within the sink device 14 as shown in the example of FIG. 1, or may be communicatively coupled to the sink device 14 (via a wire or wirelessly). The speakers 48 may represent any form of speaker, such as a loudspeaker, a headphone speaker, or a speaker in an earbud. Furthermore, although described with respect to a transducer, the speakers 48 may represent other forms of speakers, such as the “speakers” used in bone conducting headphones that send vibrations to the upper jaw, which induces sound in the human aural system.

As noted above, the apps 20 may output audio data 21 to the mixing unit 22. Prior to outputting the audio data 21, the apps 20 may interface with the operating system to initialize an audio processing path for output via integrated speakers (not shown in the example of FIG. 1) or a physical connection (such as a mini-stereo audio jack, which is also known as 3.5 millimeter—mm—minijack). As such, the audio processing path may be referred to as a wired audio processing path considering that the integrated speaker is connected by a wired connection similar to that provided by the physical connection via the mini-stereo audio jack. The wired audio processing path may represent hardware or a combination of hardware and software that processes the audio data 21 to achieve a target quality of service (QoS).

To illustrate, one of the apps 20 (which is assumed to be the app 20A for purposes of illustration) may issue, when initializing or reinitializing the wired audio processing path, one or more requests 29A for a particular QoS for the audio data 21A output by the app 20A. The request 29A may specify, as a couple of examples, a high latency (that results in high quality) wired audio processing path, a low latency (that may result in lower quality) wired audio processing path, or some intermediate latency wired audio processing path. The high latency wired audio processing path may also be referred to as a high quality wired audio processing path, while the low latency wired audio processing path may also be referred to as a low quality wired audio processing path.

The audio manager 28 may represent a unit configured to manage processing of the audio data 21. That is, the audio manager 28 may configure the wired audio processing path within source device 12 in an attempt to achieve the requested target QoS. The audio manager 28 may adjust an amount of memory dedicated to buffers along the wired audio processing path for the audio data 21, shared resource priorities assigned to the audio data 21 that control priority when processed using shared resources (such as processing cycles of a central processing unit—CPU—or processing by a digital signal processor—DSP—to provide some examples), and/or interrupt priorities assigned to the audio data 21.

Configuring the wired audio processing path to suit the latency requirements of the app 20A may allow for more immersive experiences. For example, a high latency wired audio processing path may result in higher quality audio playback that allows for better spatial resolution that places a listener more firmly (in a auditory manner) in the soundfield, thereby increasing immersion. A low latency wired audio processing path may result in more responsive audio playback that allows game and operating system sound effects to arrive in real-time or near-real-time to match on-screen graphics, allow for accurate soundfield reproduction in immersive virtual reality, augmented reality, and/or mixed-reality contexts and the like, accurate responsiveness for digital music creation contexts, and/or accurate responsiveness for playback during manipulation of virtual musical instruments.

As noted above, the source device 12 may include the audio encoder 24 by which to compress the audio data 23 prior to transmission as a bitstream 31 via the PAN. During compression, the audio encoder 24 may perform level estimation to obtain a quantization step size or some other metric used when compressing the audio data 23. When performing level estimation, the audio encoder 24 may attempt to predict current audio levels (e.g., gain) based on past audio levels. The audio encoder 24 may quantize the audio data using the quantization step size to reduce a number of bits used to represent the audio data in the bitstream 31.

Likewise, the sink device 14 may include the audio decoder 44 by which to decompress the bitstream 31 received via the PAN to obtain a decompressed version of the audio data (i.e., mixed audio data 23′ in the example of FIG. 1). The audio decoder 44 may also perform level estimation to obtain the quantization step size (and thereby allowing the audio encoder 24 to avoid signaling the quantization step size in the bitstream 31), which may be used during inverse dequantization to obtain the mixed audio data 23′.

Level estimation may, however, not be suitable for audio data 23 that includes rapidly fluctuating levels, which is present, as one example, in music featuring drums or other percussion instruments, electronic dance music (EDM), etc, as level estimation may be unable to predict the occurrence of the rapidly fluctuating levels based on previous audio levels. The result of level estimation in the context of audio data 23 including rapidly fluctuating levels may result in dampening of levels, as the quantization step size is not large enough to allow the audio encoder 24 sufficient dynamic range to represent the rapidly fluctuating levels.

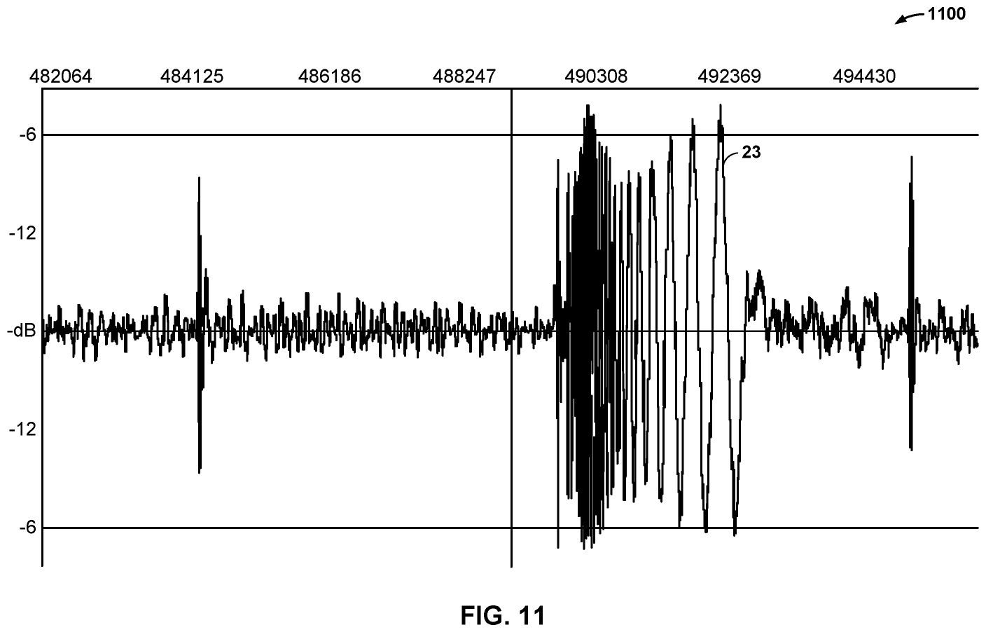

That is, there are trade-offs in terms of the optimal tuning of backward adaptation quantization. Sharper attacks (which is another way to refer to rapidly fluctuating levels) that may occur in some synthesized music, as shown in the example of FIG. 11, or drums and/or other percussion instruments, may need a different tuning for quantization than for softer (or, in other words, less rapid) level changes (such as from string instruments). FIG. 11 is a diagram illustrating a graph 1100 of example audio data 23 that includes rapid level changes, where the Y-axis denotes decibels and the X-axis denotes time. Although the audio encoder 24 may signal to the inverse quantizer of the audio decoder 44 that a rapid level change occurs in various blocks of the audio data 23, such signaling may consume bandwidth that would otherwise be used to improve a quality of encoded audio data 25.

In accordance with various aspects of the techniques described in this disclosure, the audio encoder 24 and the audio decoder 44 may obtain an indication of a current level of a current block of audio data. As such, the audio encoder 24 and the audio decoder 44 may perform level estimation relative to a current level of the current block of the audio data 23 and thereby increase a quantization step size or other metric relevant to dynamic range so as to reduce dampening of rapidly fluctuating levels in the audio data 23.

In operation, the audio encoder 24 may obtain the current indication representative of the current level of the current block of the audio data 23. During audio compression, the audio encoder 24 may perform bit allocation with respect to a portion of the audio data 23 that includes the current block of the audio data 23 to obtain a bit allocation identifying a number of bits (within a total bit budget to represent a plurality of portions including the portion in the bitstream 31) allocated to the portion of the audio data 23 that includes the current block. The bit allocation for the portion may effectively identify the current level of the current block of the audio data 23, and as such may represent one example of the current indication.

The audio encoder 24 may also obtain a previous indication representative of a previous level of a previous block of the audio data 23. The audio encoder 24 may obtain the previous indication through analysis of previous blocks relative to the current block. In some examples, the audio encoder 24 may obtain the previous indication through analysis of reconstructed versions of the previous blocks of the audio data 23, thereby reproducing the analysis that the audio decoder 44 may perform, as the audio decoder 44 does not, in many circumstances, have access to the original audio data 23.

The audio encoder 24 may next perform, based on the current indication and the previous indication, level estimation to obtain a level estimate indication representative of an estimate of the level of the current block of the audio data 23. As noted above, the level estimate indication may include a quantization step size or some other metric relevant to dynamic range (or, that may reduce the likelihood of saturation) when compressing the current block of the audio data 23. The audio encoder 24 may perform, based on the level estimate indication, compression with respect to the current block of the audio data to obtain encoded audio data 25 (which may also be referred to as a “bitstream 25”).

Given that the current indication provides additional information about the current block (and, in some examples, future blocks) of the audio data 23, the audio encoder 24 may adjust (e.g., increase) the level estimate indication to adapt compression in a manner that reduces dampening when encountering blocks of the audio data 23 that feature rapidly changing levels. Furthermore, basing the adjustment of the level estimate indication on information already specified in the bitstream 31 (for purposes of signaling bit allocations) may allow the audio encoder 24 to avoid having to separately signal (or, in other words, consume additional bits in the bitstream 31) instances in which the audio data 23 presents rapidly changing levels.

The audio encoder 24 may, in other words, leverage bit allocations as the current indication of the current level of the current block of the audio data 23. The audio encoder 24 may generally allocate more bits to portions of the audio data 23 having higher gain levels as identified using a maximum envelope of the audio data 23 over some specified or adaptive window of time, or having a higher signal to noise ratio (SNR) over some specified or adaptive window of time. Considering that the audio encoder 24 already specifies the bit allocation in the bitstream 25, the audio encoder 24 may effectively re-use the bit allocation for purposes of increasing or otherwise adjusting level estimates, thereby avoiding having to signal additional level estimate information in the bitstream 25 to allow for the adjustment of the level estimate indication.

The audio decoder 44 may operate in a manner similar to, if not the same as, the audio encoder 24 with respect to performing level estimation. However, rather than perform the bit allocation, the audio decoder 44 may obtain, from the bitstream 25, the bit allocation and reuse the bit allocation as the current indication of the current block of the audio data 23 represented in the bitstream 25. The audio decoder 44 may then obtain, in a manner similar if not the same as the audio encoder 24, the previous indication of the previous block of the audio data 23 represented in the bitstream 25.

The audio decoder 44 may next perform, based on current indication and the previous indication, level estimation to obtain the level estimate indication representative of the estimate of the level of the current block of the audio data 23 represented by the bitstream 25. Based on the level estimate indication, the audio decoder 44 may perform decompression with respect to the current block of the audio data 23 represented by the bitstream 25 to obtain a decompressed version of the current block of the mixed audio data 23′.

In this respect, the techniques may enable the audio encoder 24 and the audio decoder 44 to improve operation of the source device 12 and the sink device 14 themselves in terms of better compressing the audio data in a manner that potentially avoids injecting audio artifacts. The techniques may allow the audio encoder 24 and the audio decoder 44 to better represent the audio data (compared to level estimation based only on levels of previous blocks of audio data) without increasing a number of bits used to represent the audio data 23 in the bitstream 25. That is, the techniques may allow the audio encoder 24 and the audio decoder 44 to improve signal to noise ratios without increasing the number of bits allocated to the current block, which improves the operation of the audio encoder 24 and the audio decoder 44 themselves in contrast to merely implementing a known process using computing devices.

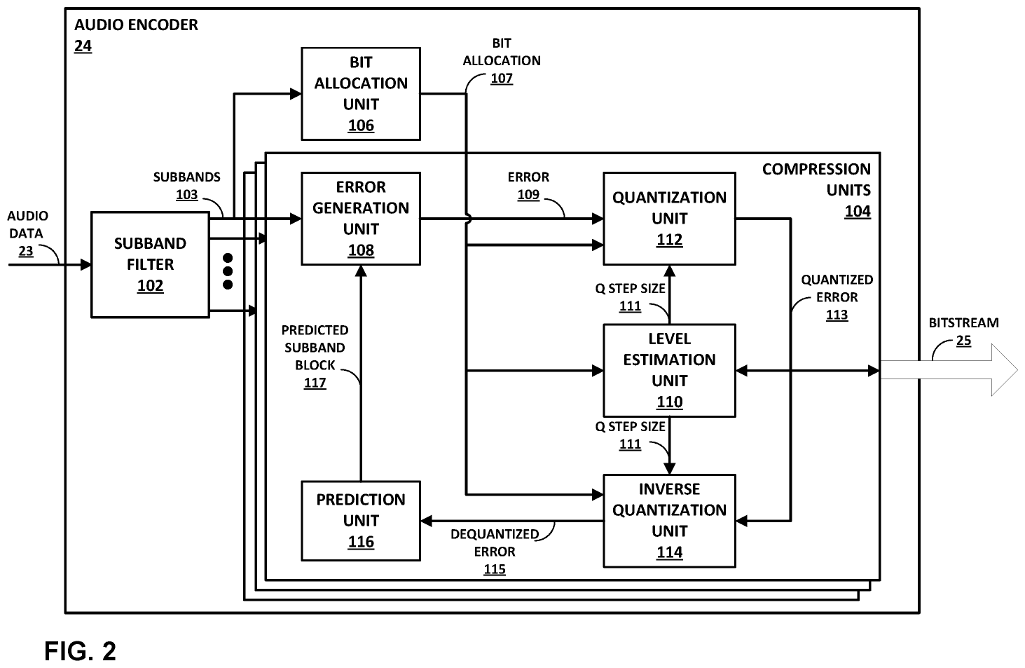

FIG. 2 is a block diagram illustrating an example of the audio encoder of FIG. 1 in performing various aspects of the techniques described in this disclosure. As shown in the example of FIG. 2, the audio encoder 24 includes a subband filter 102, compression units 104, and a bit allocation unit 106. The subband filter 102 may represent a unit configured to separate the audio data 23 (which may represent pulse code modulated—PCM—audio data) into different subbands 103 of the audio data 23 (or, more generically, different portions of the audio data 23). Examples of the subband filter 102 include a quadrature mirror filterbank (QMF) or a conjugate mirror filters (CMF, which may also be referred to as power symmetric filters—PSF). The subband filter 102 may output subbands 103 to the bit compression units 104 and the bit allocation unit 106.

The compression units 104 may represent one or more units configured to compress one or more of the subbands 103. In the example of FIG. 2, the audio encoder 24 includes a compression unit of compression units 104 for each one of the subbands 103. However, the audio encoder 24 may include a single compression unit 104 that processes each of the subbands 103, or two or more compression units 104 that may process one or more of the subbands 103.

In any event, each of the compression units 104 may be configured to perform a form of compression referred to as adaptive differential pulse code modulation (ADPCM). Although described with respect to ADPCM, the techniques may be implemented with respect to any form of compression that relies on bit allocations or other indications of a current level of a current block of the audio data 23 and level estimation in order to obtain the level estimate indication. The compression units 104 may perform ADPCM with respect to the subbands 103 to obtain quantized errors 113, which may be formatted to form the bitstream 25.

The bit allocation unit 106 may represent a unit configured to perform, based on the subbands 103, bit allocation to obtain a bit allocation for each of the subbands 103. Although not shown in the example of FIG. 2, the bit allocation unit 106 may receive a target bitrate or other indication of the target bitrate (such as a quality, SNR, etc.). The bit allocation unit 106 may then obtain, based on the target bitrate, a bit budget for a frame (or any set or adaptable number of samples) of the audio data 23.

The bit allocation unit 106 may analyze each of the subbands 103 to identify which of the subbands 103 include information salient in representing the soundfield captured by the audio data 23, and thereby allocate portions of the bit budget to one or more of the subbands 103. In some examples, the bit allocation unit 106 may determine a maximum PAR envelope for each of the subbands 103 and identify which of the subbands 103 should receive more bits than other ones of the subbands 103 (possibly performing differentiation and integration between the different subbands 103 to identify redundancies, etc.). The bit allocation unit 106 may, in some instances, identify a SNR for each of the subbands 103 as an alternative to the maximum PAR envelope or in conjunction with the maximum PAR envelope. The bit allocation unit 106 may then provide the bit allocation 107 for each of the subbands 107 to a corresponding one of the compression units 104.

As further shown in the example of FIG. 2, the compression units 104 may each include an error generation unit 108, a level estimation unit 110, a quantization unit 112, an inverse quantization unit 114, and a prediction unit 116. The error generation unit 108 may represent a unit configured to obtain an error 109 as a difference between a current block of the subband 103, and a predicted subband block 117 predicted from a previous block of the subband 103. The previous block of the subband 103 may include a block that is temporally directly before the current block of the subband 103. The error generation unit 108 may output the error 109 to quantization unit 112.

The level estimation unit 110 may represent a unit configured to perform level estimation with respect to previous blocks of the subband 103. The level estimation unit 110 may receive quantized errors 113 as codewords having, as one example, bit lengths of two to nine bits. The quantized errors 113 may represent an example of previous indications of the levels of previous blocks of subband 103.

The level estimation unit 110 may perform, based on one or more of the quantized errors 113, level estimation 110 to obtain quantization step size 111 (“Q step size 111”). More information concerning how to perform level estimation with respect to only quantized errors 113 can be found at section 3.2.3 (in reference to Adaptive Quantizers and referred to as “adaptive-backward prediction”) in a Thesis Paper by Watts, Lloyd, entitled “VECTOR QUANTIZATION AND SCALAR LINEAR PREDICTION FOR WAVEFORM CODING OF SPEECH AT 16 kb§,” and dated June 1989. The level estimation unit 110 may output the quantization step size 111 to both the quantization unit 112 and the inverse quantization unit 114.

The quantization unit 112 may represent a unit configured to perform uniform or non-uniform quantization with respect to the error 109. Uniform quantization may refer to quantization in which the quantization levels or intervals are uniform (or, in other words, the same). Non-uniform quantization may refer to quantization in which the quantization levels or intervals are not uniform. For purposes of illustration, it is assumed that quantization unit 112 may perform non-uniform quantization as the audio data 23 may generally not have a uniform distribution of samples especially in the presence of rapidly changing levels.

In any event, the quantization unit 112 may perform adaptive quantization (which is a form of lossy compression) based on quantization step size 111, where such quantization is adaptive given that the quantization step size 111 may change. The quantization unit 112 may perform, based on the quantization step size 111, non-uniform quantization with respect to the error 109 to obtain the quantized error 113. The quantization unit 112 may output the quantized error 113 to the level estimation unit 110, as noted above, and the inverse quantization unit 114.

The inverse quantization unit 114 may represent a unit configured to perform inverse quantization, based on the quantization step size 111, with respect to the quantized error 113 to obtain the dequantized error 115. In this respect, the inverse quantization unit 114 may operate reciprocally to the quantization unit 112. The inverse quantization unit 114 may output the dequantized error 115 to the prediction unit 116.

The prediction unit 116 may represent a unit configured to predict, based on dequantized error 115, subband 103 to obtain predicted subband block 117. The prediction unit 116 may obtain the predicted subband block 117 by, as one example, adding dequantized error 115 to a previously predicted subband block 117 for subband 103. The prediction unit 116 may output the predicted subband block 117 to the error generation unit 108, as noted above.

As noted above, the level estimation unit 110 may perform, based on quantized errors 113, level estimation to obtain the level estimate indication 111 (which as one example may include the quantization step size 111 shown in the example of FIG. 2). The level estimator 110 may also adapt, as part of the level estimation, the level estimate indication 111 based on the bit allocation 107. In some examples, when the bit allocation 107 is greater than or equal to a threshold, the level estimation unit 110 may increase the level estimate indication 111 in order to increase a dynamic range of quantization performed by quantization unit 112.

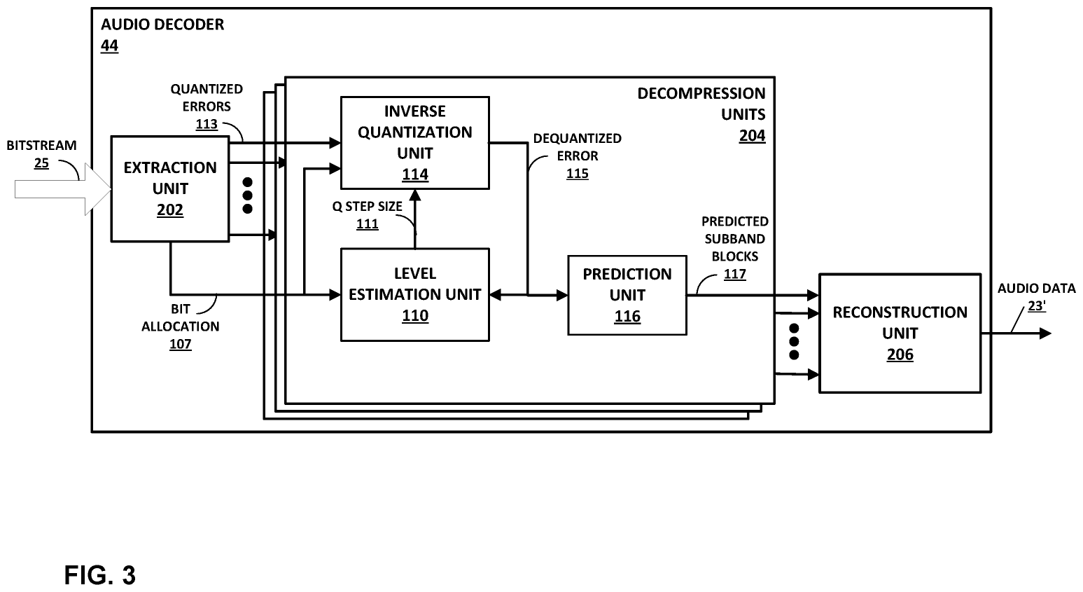

FIG. 3 is a block diagram illustrating an example of the audio decoder of FIG. 1 in performing various aspects of the techniques described in this disclosure. As shown in the example of FIG. 3, the audio decoder 44 includes an extraction unit 202, decompression units 204, and a reconstruction unit 206. The extraction unit 202 may represent a unit configured to extract or otherwise parse various values from the bitstream 25, such as the quantized errors 113 and corresponding bit allocations 107.

The decompression units 204 may each represent a unit configured to perform reciprocal operations to those described above with respect to compression units 104. In the example of FIG. 2, the audio decoder 44 includes a decompression unit of decompression units 204 for each one of the quantized errors 103. However, the audio decoder 44 may include a single decompression unit 204 that processes each of the quantized errors 113, or two or more decompression units 204 that may process one or more of the quantized errors 113.

Each of the decompression units 204 may perform inverse ADPCM compression to obtain predicted subband blocks 117. Each of decompression units 204 may output predicted subband blocks 117 to reconstruction unit 206. Although described with respect to inverse ADPCM, the techniques may be implemented with respect to any form of decompression that relies on bit allocations or other indications of a current level of a current block of the audio data 23 and level estimation in order to obtain the level estimate indication 111. The decompression units 204 may output predicted subband blocks 117 to reconstruction unit 206.

The reconstruction unit 206 may represent a unit configured to reconstruct, based on predicted subband blocks 117 from each of the decompression units 204, audio data 23′. The reconstruction unit 206 may apply an inverse subband filter (not shown) in a manner reciprocal to the subband filter 102 with respect to the predicted subband blocks 117 to obtain the audio data 23′.

As further shown in the example of FIG. 3, each of the decompression units 204 includes a level estimation unit 110, an inverse quantization unit 114, and a prediction unit 116. The level estimation unit 110, the inverse quantization unit 114, and the prediction unit 116 of the decompression units 204 may each operate in a manner substantially similar to, if not the same as, the level estimation unit 110, the inverse quantization unit 114, and the prediction unit 116, respectively, of the compression units 104 of the audio encoder 24 shown in the example of FIG. 2.

The level estimation unit 110 of the decompression units 204 may represent a unit configured to perform level estimation with respect to previous blocks of the subband 103. The level estimation unit 110 may receive quantized errors 113 as codewords having, as one example, bit lengths of two to nine bits. The quantized errors 113 may represent an example of previous indications of the levels of previous blocks of subband 103.

The level estimation unit 110 may perform, based on one or more of the quantized errors 113, level estimation 110 to obtain quantization step size 111 (“Q step size 111”). More information concerning how to perform level estimation with respect to only quantized errors 113 can be found at section 3.2.3 (in reference to Adaptive Quantizers and referred to as “adaptive-backward prediction”) in a Thesis Paper by Watts, Lloyd, entitled “VECTOR QUANTIZATION AND SCALAR LINEAR PREDICTION FOR WAVEFORM CODING OF SPEECH AT 16 kb§,” and dated June 1989. The level estimation unit 110 may output the quantization step size 111 to the inverse quantization unit 114.

The inverse quantization unit 114 may represent a unit configured to perform inverse quantization, based on the quantization step size 111, with respect to the quantized error 113 to obtain the dequantized error 115. In this respect, the inverse quantization unit 114 may operate reciprocally to the quantization unit 112 of the compression units 104. The inverse quantization unit 114 may output the dequantized error 115 to the prediction unit 116.

The prediction unit 116 may represent a unit configured to predict, based on dequantized error 115, subband 103 to obtain predicted subband block 117. The prediction unit 116 may obtain the predicted subband block 117 by, as one example, adding dequantized error 115 to a previously predicted subband block 117 for subband 103. The prediction unit 116 may output the predicted subband block 117 to the reconstruction unit 206, as noted above.

As noted above, the level estimation unit 110 may perform, based on quantized errors 113, level estimation to obtain the level estimate indication 111 (which as one example may include the quantization step size 111 shown in the example of FIG. 2). The level estimator 110 may also adapt, as part of the level estimation, the level estimate indication 111 based on the bit allocation 107. In some examples, when the bit allocation 107 is greater than or equal to a threshold, the level estimation unit 110 may increase the level estimate indication 111 in order to increase a dynamic range of quantization performed by quantization unit 112.

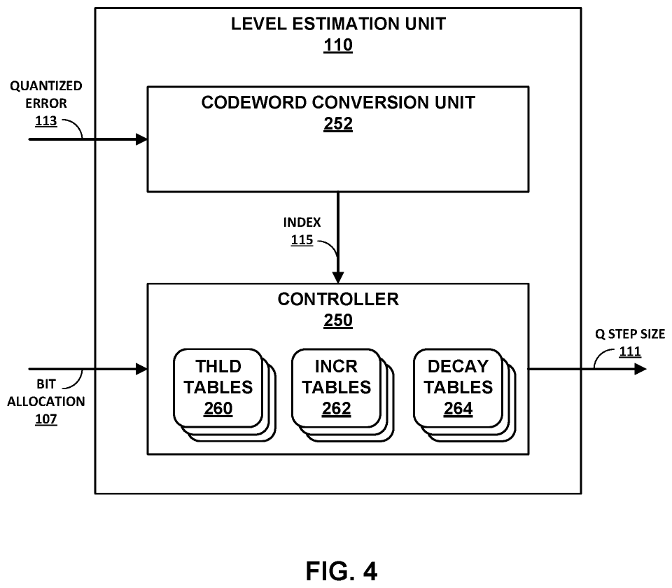

FIG. 4 is a block diagram illustrating an example of the level estimation unit shown in FIGS. 2 and 3 in more detail. As shown in the example of FIG. 4, the level estimation unit 110 includes a codeword conversion unit 250 and a controller 252. The codeword conversion unit 250 may represent a unit configured to perform inverse quantization with respect to the quantized error 113 to obtain the dequantized error 115, which may also be used as an index 115 into various tables 260-264 stored by the controller 252.

The controller 252 may represent a unit configured to obtain, based on the index 115 output by codeword conversion unit 250 (which is representative of an indication of a previous level of a previous block of the audio data) and the bit allocation 107, quantization step size 111. The controller 252 may select, based on the bit allocation 107, one of each of threshold tables 260 (“THLD TABLES 260”), increment tables 262 (“INCR TABLES 262”), and decay tables 264 (which may store values corresponding to different log functions).

The controller 252 may next identify, using the index 115 as a key into the selected one of the threshold tables 260, a threshold value. The controller 252 may next identify, using the index 115 as a key into the selected one of the increment tables 262, an increment value. Further, the controller 252 may identify, using the index 115 as a key into the selected one of the decay tables 262, a decay value. The controller 250 may obtain, based on the threshold value, the increment value, and the decay value, an accumulator value. The controller 252 may then obtain, based on the accumulator value, the quantization step size 111.

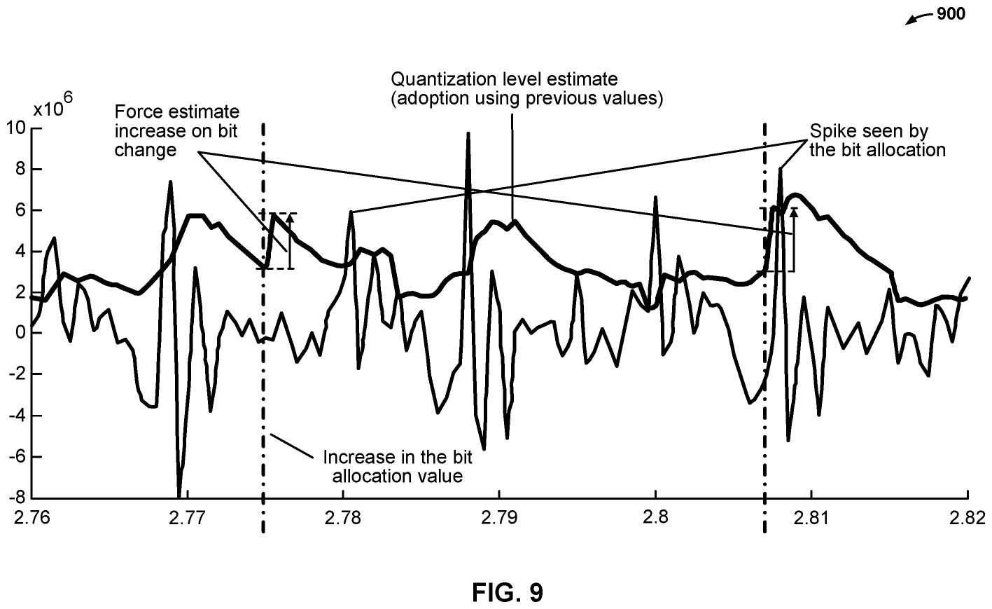

FIG. 9 is a diagram illustrating a graph 900 in which the level estimation unit shown in the example of FIG. 4 may increase the quantization step size responsive to an increase in a value of the bit allocation.

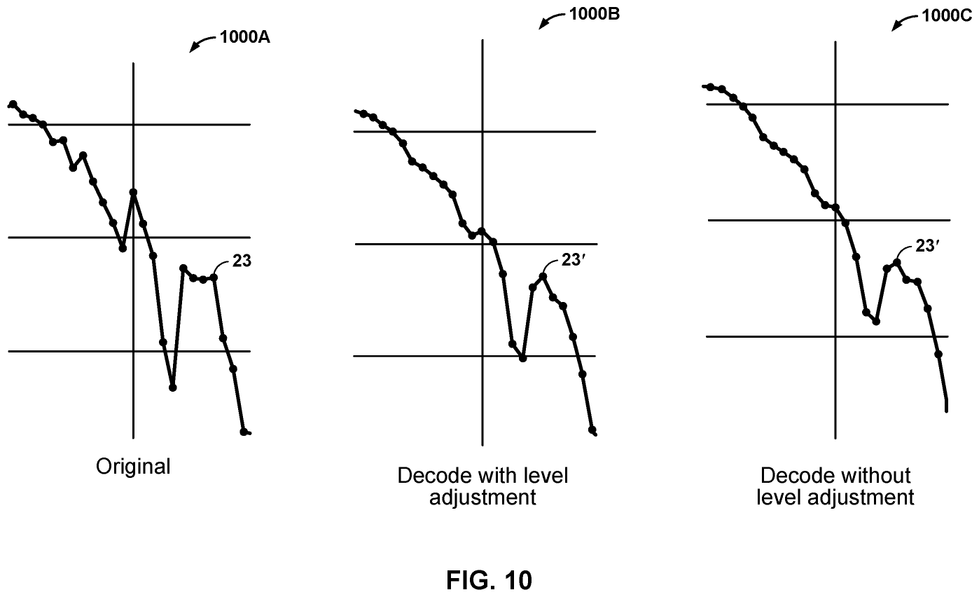

FIG. 10 is a diagram illustrating graphs 1000A-1000C depicting how the level estimation unit shown in the example of FIG. 4 may reduce dampening during rapid levels changes. The graph 1000A represents the original audio data 23. The graph 1000B represents the audio data 23′ when processed by the level estimation unit 110 in accordance with various aspects of the techniques described in this disclosure, while the graphs 1000C represents the audio data 23′ when processed by the level estimation unit that performs level estimation using only previous levels of previous blocks of audio data. The graph 1000B clearly shows that the techniques promote reduced dampening of the audio data 23′ compared to the audio data 23′ shown in the graph 1000C.

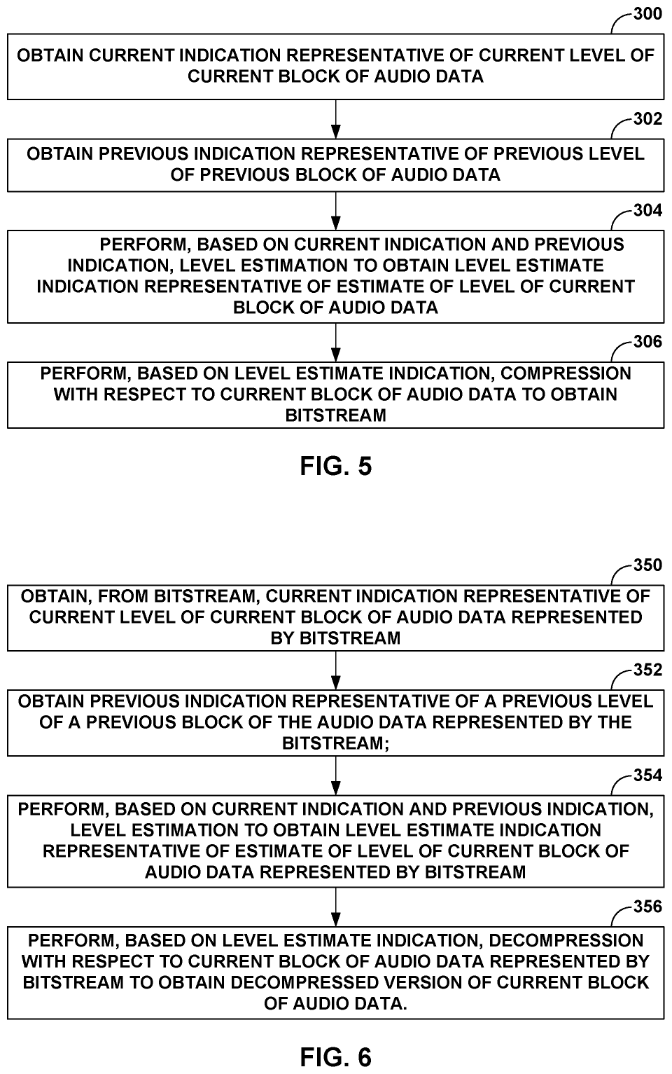

FIG. 5 is a flowchart illustrating example operation of the source device 12 of FIG. 1 in performing various aspects of the techniques described in this disclosure. As shown in the example of FIG. 5, the source device 12 may first obtain a current indication representative of a current level of a current block of the audio data (300). The source device 12 may also obtain a previous indication representative of a previous level of a previous block of the audio data (302). The source device 12 may further perform, based on the current indication and the previous indication, level estimation to obtain a level estimate indication representative of an estimate of the level of the current block of the audio data (304). The source device 12 may perform, based on the level estimate indication, compression with respect to the current block of the audio data to obtain a bitstream (306).

FIG. 6 is a flowchart illustrating example operation of the sink device 14 of FIG. 1 in performing various aspects of the techniques described in this disclosure. As shown in the example of FIG. 6, the sink device 14 may first obtain, from the bitstream, a current indication representative of a current level of a current block of the audio data represented by the bitstream (350). The sink device 14 may also obtain a previous indication representative of a previous level of a previous block of the audio data represented by the bitstream (352). The sink device 14 may perform, based on the current indication and the previous indication, level estimation to obtain a level estimate indication representative of an estimate of the level of the current block of the audio data represented by the bitstream (354). The sink device 14 may also perform, based on the level estimate indication, decompression with respect to the current block of the audio data represented by the bitstream to obtain a decompressed version of the current block of the audio data (356).

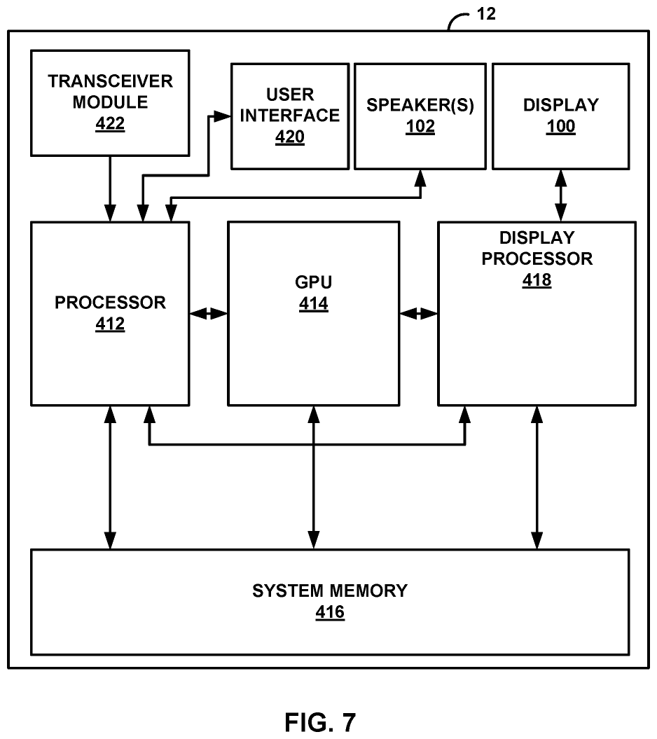

FIG. 7 is a block diagram illustrating example components of the source device 12 shown in the example of FIG. 1. In the example of FIG. 7, the source device 12 includes a processor 412, a graphics processing unit (GPU) 414, system memory 416, a display processor 418, one or more integrated speakers 102, a display 100, a user interface 420, and a transceiver module 422. In examples where the source device 12 is a mobile device, the display processor 418 is a mobile display processor (MDP). In some examples, such as examples where the source device 12 is a mobile device, the processor 412, the GPU 414, and the display processor 418 may be formed as an integrated circuit (IC).

For example, the IC may be considered as a processing chip within a chip package, and may be a system-on-chip (SoC). In some examples, two of the processors 412, the GPU 414, and the display processor 418 may be housed together in the same IC and the other in a different integrated circuit (i.e., different chip packages) or all three may be housed in different ICs or on the same IC. However, it may be possible that the processor 412, the GPU 414, and the display processor 418 are all housed in different integrated circuits in examples where the source device 12 is a mobile device.

Examples of the processor 412, the GPU 414, and the display processor 418 include, but are not limited to, one or more digital signal processors (DSPs), general purpose microprocessors, application specific integrated circuits (ASICs), field programmable logic arrays (FPGAs), or other equivalent integrated or discrete logic circuitry. The processor 412 may be the central processing unit (CPU) of the source device 12. In some examples, the GPU 414 may be specialized hardware that includes integrated and/or discrete logic circuitry that provides the GPU 414 with massive parallel processing capabilities suitable for graphics processing. In some instances, GPU 14 may also include general purpose processing capabilities, and may be referred to as a general purpose GPU (GPGPU) when implementing general purpose processing tasks (i.e., non-graphics related tasks). The display processor 418 may also be specialized integrated circuit hardware that is designed to retrieve image content from the system memory 416, compose the image content into an image frame, and output the image frame to the display 100.

The processor 412 may execute various types of the applications 20. Examples of the applications 20 include web browsers, e-mail applications, spreadsheets, video games, other applications that generate viewable objects for display, or any of the application types listed in more detail above. The system memory 416 may store instructions for execution of the applications 20. The execution of one of the applications 20 on the processor 412 causes the processor 412 to produce graphics data for image content that is to be displayed and the audio data 21 that is to be played (possibly via integrated speaker 102). The processor 412 may transmit graphics data of the image content to the GPU 414 for further processing based on and instructions or commands that the processor 412 transmits to the GPU 414.

The processor 412 may communicate with the GPU 414 in accordance with a particular application processing interface (API). Examples of such APIs include the DirectX® API by Microsoft®, the OpenGL® or OpenGL ES® by the Khronos group, and the OpenCL′; however, aspects of this disclosure are not limited to the DirectX, the OpenGL, or the OpenCL APIs, and may be extended to other types of APIs. Moreover, the techniques described in this disclosure are not required to function in accordance with an API, and the processor 412 and the GPU 414 may utilize any technique for communication.

The system memory 416 may be the memory for the source device 12. The system memory 416 may comprise one or more computer-readable storage media. Examples of the system memory 416 include, but are not limited to, a random access memory (RAM), an electrically erasable programmable read-only memory (EEPROM), flash memory, or other medium that can be used to carry or store desired program code in the form of instructions and/or data structures and that can be accessed by a computer or a processor.

In some aspects, the system memory 416 may include instructions that cause the processor 412, the GPU 414, and/or the display processor 418 to perform the functions ascribed in this disclosure to the processor 412, the GPU 414, and/or the display processor 418. Accordingly, the system memory 416 may be a computer-readable storage medium having instructions stored thereon that, when executed, cause one or more processors (e.g., the processor 412, the GPU 414, and/or the display processor 418) to perform various functions.

The system memory 416 may include a non-transitory storage medium. The term “non-transitory” indicates that the storage medium is not embodied in a carrier wave or a propagated signal. However, the term “non-transitory” should not be interpreted to mean that the system memory 416 is non-movable or that its contents are static. As one example, the system memory 416 may be removed from the source device 12, and moved to another device. As another example, memory, substantially similar to the system memory 416, may be inserted into the source device 12. In certain examples, a non-transitory storage medium may store data that can, over time, change (e.g., in RAM).

The user interface 420 may represent one or more hardware or virtual (meaning a combination of hardware and software) user interfaces by which a user may interface with the source device 12. The user interface 420 may include physical buttons, switches, toggles, lights or virtual versions thereof. The user interface 420 may also include physical or virtual keyboards, touch interfaces—such as a touchscreen, haptic feedback, and the like.

The processor 412 may include one or more hardware units (including so-called “processing cores”) configured to perform all or some portion of the operations discussed above with respect to one or more of the mixing unit 22, the audio encoder 24, the wireless connection manager 26, the audio manager 28, and the wireless communication units 30. The transceiver module 422 may represent a unit configured to establish and maintain the wireless connection between the source device 12 and the sink device 14. The transceiver module 422 may represent one or more receivers and one or more transmitters capable of wireless communication in accordance with one or more wireless communication protocols. The transceiver module 422 may perform all or some portion of the operations of one or more of the wireless connection manager 26 and the wireless communication units 30.

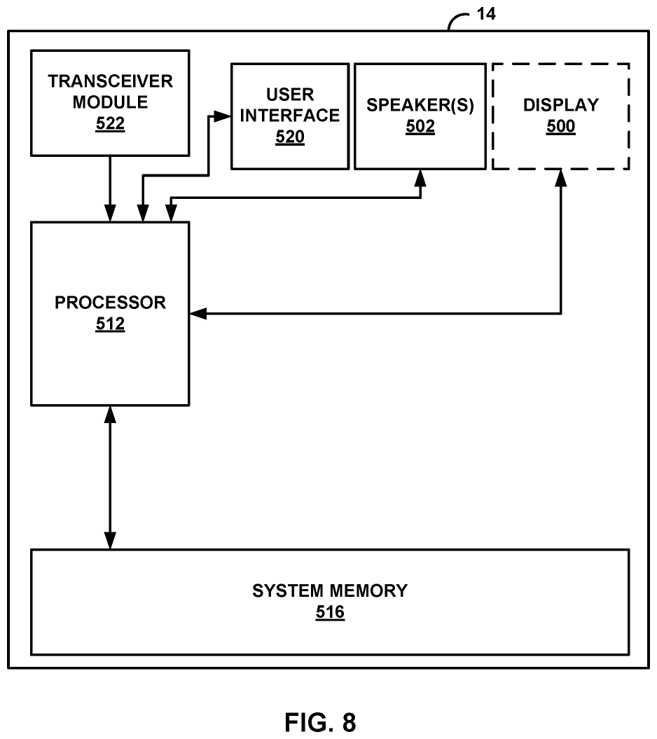

FIG. 8 is a block diagram illustrating exemplary components of the sink device 14 shown in the example of FIG. 1. Although the sink device 14 may include components similar to that of the source device 12 discussed above in more detail with respect to the example of FIG. 7, the sink device 14 may, in certain instances, include only a subset of the components discussed above with respect to the source device 12.

In the example of FIG. 8, the sink device 14 includes one or more speakers 502, a processor 512, a system memory 516, a user interface 520, and a transceiver module 522. The processor 512 may be similar or substantially similar to the processor 412. In some instances, the processor 512 may differ from the processor 412 in terms of total processing capacity or may be tailored for low power consumption. The system memory 516 may be similar or substantially similar to the system memory 416. The speakers 502, the user interface 520, and the transceiver module 522 may be similar to or substantially similar to the respective speakers 402, user interface 420, and transceiver module 422. The sink device 14 may also optionally include a display 500, although the display 500 may represent a low power, low resolution (potentially a black and white LED) display by which to communicate limited information, which may be driven directly by the processor 512.

The processor 512 may include one or more hardware units (including so-called “processing cores”) configured to perform all or some portion of the operations discussed above with respect to one or more of the wireless connection manager 40, the wireless communication units 42, the audio decoder 44, and the audio manager 26. The transceiver module 522 may represent a unit configured to establish and maintain the wireless connection between the source device 12 and the sink device 14. The transceiver module 522 may represent one or more receivers and one or more transmitters capable of wireless communication in accordance with one or more wireless communication protocols. The transceiver module 522 may perform all or some portion of the operations of one or more of the wireless connection manager 40 and the wireless communication units 28.

The foregoing techniques may be performed with respect to any number of different contexts and audio ecosystems. A number of example contexts are described below, although the techniques should be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed comprises an audio ecosystem that may include broadcast recording audio objects, professional audio systems, consumer on-device capture, HOA audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into various representations for playback by one or more of the playback elements. For instance, a user of the mobile device may record (acquire a soundfield of) a live event (e.g., a meeting, a conference, a play, a concert, etc.), and code the recording into various representation, including higher order ambisonic HOA representations.

The mobile device may also utilize one or more of the playback elements to playback the coded soundfield. For instance, the mobile device may decode the coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a headset or headphones, e.g., to create realistic binaural sound.

In some examples, a particular mobile device may both acquire a soundfield and playback the same soundfield at a later time. In some examples, the mobile device may acquire a soundfield, encode the soundfield, and transmit the encoded soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of audio signals. For instance, the one or more DAWs may include audio plugins and/or tools which may be configured to operate with (e.g., work with) one or more game audio systems. In some examples, the game studios may output new stem formats that support audio format. In any case, the game studios may output coded audio content to the rendering engines which may render a soundfield for playback by the delivery systems.

The mobile device may also, in some instances, include a plurality of microphones that are collectively configured to record a soundfield, including 3D soundfields. In other words, the plurality of microphone may have X, Y, Z diversity. In some examples, the mobile device may include a microphone which may be rotated to provide X, Y, Z diversity with respect to one or more other microphones of the mobile device.

A ruggedized video capture device may further be configured to record a soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a soundfield that represents the action all around the user (e.g., water crashing behind the user, another rafter speaking in front of the user, etc. . . . ).

The techniques may also be performed with respect to an accessory enhanced mobile device, which may be configured to record a soundfield, including a 3D soundfield. In some examples, the mobile device may be similar to the mobile devices discussed above, with the addition of one or more accessories. For instance, an microphone, including an Eigen microphone, may be attached to the above noted mobile device to form an accessory enhanced mobile device. In this way, the accessory enhanced mobile device may capture a higher quality version of the soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a soundfield, including a 3D soundfield. Moreover, in some examples, headphone playback devices may be coupled to a decoder via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a rendered to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the soundfield, including 3D soundfields, of the sports game may be acquired (e.g., one or more microphones and/or Eigen microphones may be placed in and/or around the baseball stadium). HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the source device 12 may perform a method or otherwise comprise means to perform each step of the method for which the source device 12 is described above as performing. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the source device 12 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the sink device 14 may perform a method or otherwise comprise means to perform each step of the method for which the sink device 14 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the sink device 14 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

In this respect, various aspects of the techniques may enable the following devices, methods, and computer-readable medium to operate as set forth in the following clauses.

Clause 1A. A source device configured to process audio data, the source device comprising: a memory configured to store at least a portion of the audio data; and one or more processors coupled to the memory, and configured to: obtain a current indication representative of a current level of a current block of the audio data; obtain a previous indication representative of a previous level of a previous block of the audio data; perform, based on the current indication and the previous indication, level estimation to obtain a level estimate indication representative of an estimate of the level of the current block of the audio data; and perform, based on the level estimate indication, compression with respect to the current block of the audio data to obtain a bitstream.

Clause 2A. The source device of clause 1A, wherein the one or more processors are further configured to perform bit allocation with respect to a portion of the audio data that includes the current block to obtain a bit allocation identifying a number of bits allocated to the portion of the audio data that includes the current block, and wherein the current indication includes the bit allocation.

Clause 3A. The source device of clause 1A, wherein the one or more processors are further configured to: apply a filter to the audio data to obtain a plurality of filtered portions of audio data, and perform bit allocation with respect to one of the plurality of filtered portions of the audio data that includes the current block to obtain a bit allocation identifying a number of bits allocated to the one of the plurality of filtered portions of the audio data that includes the current block, wherein the current indication includes the bit allocation.

Clause 4A. The source device of clause 3A, wherein the filter comprises a subband filter, and wherein the plurality of filtered portions comprises a plurality of subbands.

Clause 5A. The source device of any combination of clauses 1A-4A, wherein the one or more processors are configured to: perform, based on the previous indication, level estimation to obtain the level estimate indication; compare, after obtaining the level estimate indication, the current indication to a threshold; and increase, when the current indication is greater than or equal to the threshold, the level estimate indication.

Clause 6A. The source device of any combination of clauses 1A-5A, wherein the level estimate indication comprises a quantization step size, wherein the one or more processors are configured to perform, based on the quantization step size, quantization with respect to the current block to obtain the bitstream.

Clause 7A. The source device of any combination of clauses 1A-6A, further comprising a transceiver configured to transmit the bitstream to a sink device in accordance with a wireless communication protocol.

Clause 8A. The source device of clause 7A, wherein the wireless communication protocol comprises a personal area network wireless communication protocol.

Clause 9A. The source device of clause 7A, wherein the personal area network wireless communication protocol comprises a Bluetooth® wireless communication protocol.

Clause 10A. The source device of clause 7A, wherein the personal area network wireless communication protocol comprises a Bluetooth® wireless communication protocol operating according to the advance audio distribution profile.

Clause 11A. A method of processing audio data, the method comprising: obtaining a current indication representative of a current level of a current block of the audio data; obtaining a previous indication representative of a previous level of a previous block of the audio data; performing, based on the current indication and the previous indication, level estimation to obtain a level estimate indication representative of an estimate of the level of the current block of the audio data; and performing, based on the level estimate indication, compression with respect to the current block of the audio data to obtain a bitstream.

Clause 12A. The method of clause 11A, further comprising performing bit allocation with respect to a portion of the audio data that includes the current block to obtain a bit allocation identifying a number of bits allocated to the portion of the audio data that includes the current block, wherein the current indication includes the bit allocation.

Clause 13A. The method of clause 11A, further comprising: applying a filter to the audio data to obtain a plurality of filtered portions of audio data, and performing bit allocation with respect to one of the plurality of filtered portions of the audio data that includes the current block to obtain a bit allocation identifying a number of bits allocated to the one of the plurality of filtered portions of the audio data that includes the current block, wherein the current indication includes the bit allocation.

Clause 14A. The method of clause 13A, wherein the filter comprises a subband filter, and wherein the plurality of filtered portions comprises a plurality of subbands.

Clause 15A. The method of any combination of clauses 11A-14A, wherein performing the level estimation comprises: performing, based on the previous indication, the level estimation to obtain the level estimate indication; comparing, after obtaining the level estimate indication, the current indication to a threshold; and increasing, when the current indication is greater than or equal to the threshold, the level estimate indication.

Clause 16A. The method of any combination of clauses 11A-15A, wherein the level estimate indication comprises a quantization step size, wherein performing the compression comprises performing, based on the quantization step size, quantization with respect to the current block to obtain the bitstream.

Clause 17A. The method of any combination of clauses 11A-16A, further comprising transmitting the bitstream to a sink device in accordance with a wireless communication protocol.

Clause 18A. The method of clause 17A, wherein the wireless communication protocol comprises a personal area network wireless communication protocol.

Clause 19A. The method of clause 17A, wherein the personal area network wireless communication protocol comprises a Bluetooth® wireless communication protocol.

Clause 20A. The method of clause 17A, wherein the personal area network wireless communication protocol comprises a Bluetooth® wireless communication protocol operating according to the advance audio distribution profile.

Clause 21A. A source device configured to process audio data, the source device comprising: means for obtaining a current indication representative of a current level of a current block of the audio data; means for obtaining a previous indication representative of a previous level of a previous block of the audio data; means for performing, based on the current indication and the previous indication, level estimation to obtain a level estimate indication representative of an estimate of the level of the current block of the audio data; and means for performing, based on the level estimate indication, compression with respect to the current block of the audio data to obtain a bitstream.

Clause 22A. The source device of clause 21A, further comprising means for performing bit allocation with respect to a portion of the audio data that includes the current block to obtain a bit allocation identifying a number of bits allocated to the portion of the audio data that includes the current block, wherein the current indication includes the bit allocation.

Clause 23A. The source device of clause 21A, further comprising: means for applying a filter to the audio data to obtain a plurality of filtered portions of audio data, and means for performing bit allocation with respect to one of the plurality of filtered portions of the audio data that includes the current block to obtain a bit allocation identifying a number of bits allocated to the one of the plurality of filtered portions of the audio data that includes the current block, wherein the current indication includes the bit allocation.

Clause 24A. The source device of clause 23A, wherein the filter comprises a subband filter, and wherein the plurality of filtered portions comprises a plurality of subbands.

Clause 25A. The source device of any combination of clauses 21A-24A, wherein the means for performing the level estimation comprises: means for performing, based on the previous indication, the level estimation to obtain the level estimate indication; means for comparing, after obtaining the level estimate indication, the current indication to a threshold; and means for increasing, when the current indication is greater than or equal to the threshold, the level estimate indication.

Clause 26A. The source device of any combination of clauses 21A-25A,

wherein the level estimate indication comprises a quantization step size, wherein the means for performing the compression comprises means for performing, based on the quantization step size, quantization with respect to the current block to obtain the bitstream.

Clause 27A. The source device of any combination of clauses 21A-26A, further comprising means for transmitting the bitstream to a sink device in accordance with a wireless communication protocol.

Clause 28A. The source device of clause 27A, wherein the wireless communication protocol comprises a personal area network wireless communication protocol.

Clause 29A. The source device of clause 27A, wherein the personal area network wireless communication protocol comprises a Bluetooth® wireless communication protocol.

Clause 30A. The source device of clause 27A, wherein the personal area network wireless communication protocol comprises a Bluetooth® wireless communication protocol operating according to the advance audio distribution profile.

Clause 31A. A computer-readable medium having stored thereon instructions that, when executed, cause one or more processors of a source device to: obtain a current indication representative of a current level of a current block of audio data; obtain a previous indication representative of a previous level of a previous block of the audio data; perform, based on the current indication and the previous indication, level estimation to obtain a level estimate indication representative of an estimate of the level of the current block of the audio data; and perform, based on the level estimate indication, compression with respect to the current block of the audio data to obtain a bitstream.

Clause 1B. A sink device configured to process a bitstream representative of audio data, the sink device comprising: a memory configured to store at least a portion of the bitstream; and one or more processors coupled to the memory, and configured to: obtain, from the bitstream, a current indication representative of a current level of a current block of the audio data represented by the bitstream; obtain a previous indication representative of a previous level of a previous block of the audio data represented by the bitstream; perform, based on the current indication and the previous indication, level estimation to obtain a level estimate indication representative of an estimate of the level of the current block of the audio data represented by the bitstream; and perform, based on the level estimate indication, decompression with respect to the current block of the audio data represented by the bitstream to obtain a decompressed version of the current block of the audio data.

Clause 2B. The sink device of clause 1B, wherein the one or more processors are further configured to obtain a bit allocation identifying a number of bits allocated to a portion of the audio data represented by the bitstream that includes the current block, and wherein the current indication includes the bit allocation.

Clause 3B. The sink device of clause 2B, wherein the portion of the audio data includes a filtered portion of a plurality of filtered portions of the audio data.

Clause 4B. The sink device of clause 3B, wherein the plurality of filtered portions comprises a plurality of subbands.

Clause 5B. The sink device of any combination of clauses 1B-4B, wherein the one or more processors are configured to: perform, based on the previous indication, level estimation to obtain the level estimate indication; compare, after obtaining the level estimate indication, the current indication to a threshold; and increase, when the current indication is greater than or equal to the threshold, the level estimate indication.

Clause 6B. The sink device of any combination of clauses 1B-5B, wherein the level estimate indication comprises a quantization step size, and wherein the one or more processors are configured to perform, based on the quantization step size, inverse quantization with respect to the current block of the audio data represented by the bitstream to obtain the decompressed version of the current block.

Clause 7B. The sink device of any combination of clauses 1B-6B, further comprising a transceiver configured to receive the bitstream via a wireless connection in accordance with a wireless communication protocol.

Clause 8B. The sink device of clause 7B, wherein the wireless communication protocol comprises a personal area network wireless communication protocol.

Clause 9B. The sink device of clause 8B, wherein the personal area network wireless communication protocol comprises a Bluetooth® wireless communication protocol.

Clause 10B. The sink device of clause 8B, wherein the personal area network wireless communication protocol comprises a Bluetooth® wireless communication protocol operating according to the advance audio distribution profile.

Clause 11B. A method of processing a bitstream representative of audio data, the method comprising: obtaining, from the bitstream, a current indication representative of a current level of a current block of the audio data represented by the bitstream; obtaining a previous indication representative of a previous level of a previous block of the audio data represented by the bitstream; performing, based on the current indication and the previous indication, level estimation to obtain a level estimate indication representative of an estimate of the level of the current block of the audio data represented by the bitstream; and performing, based on the level estimate indication, decompression with respect to the current block of the audio data represented by the bitstream to obtain a decompressed version of the current block of the audio data.

Clause 12B. The method of clause 11B, further comprising obtaining a bit allocation identifying a number of bits allocated to a portion of the audio data represented by the bitstream that includes the current block, and wherein the current indication includes the bit allocation.

Clause 13B. The method of clause 12B, wherein the portion of the audio data includes a filtered portion of a plurality of filtered portions of the audio data.

Clause 14B. The method of clause 13B, wherein the plurality of filtered portions comprises a plurality of subbands.

Clause 15B. The method of any combination of clauses 11B-14B, wherein performing the level estimation comprises: performing, based on the previous indication, the level estimation to obtain the level estimate indication; comparing, after obtaining the level estimate indication, the current indication to a threshold; and increasing, when the current indication is greater than or equal to the threshold, the level estimate indication.

Clause 16B. The method of any combination of clauses 11B-15B, wherein the level estimate indication comprises a quantization step size, and wherein performing the compression comprises performing, based on the quantization step size, inverse quantization with respect to the current block of the audio data represented by the bitstream to obtain the decompressed version of the current block.

Clause 17B. The method of any combination of clauses 11-16B, further comprising receiving the bitstream via a wireless connection in accordance with a wireless communication protocol.

Clause 18B. The method of clause 17B, wherein the wireless communication protocol comprises a personal area network wireless communication protocol.

Clause 19B. The method of clause 18B, wherein the personal area network wireless communication protocol comprises a Bluetooth® wireless communication protocol.

Clause 20B. The method of clause 18B, wherein the personal area network wireless communication protocol comprises a Bluetooth® wireless communication protocol operating according to the advance audio distribution profile.

Clause 21B. A sink device configured to process a bitstream representative of audio data, the sink device comprising: means for obtaining, from the bitstream, a current indication representative of a current level of a current block of the audio data represented by the bitstream; means for obtaining a previous indication representative of a previous level of a previous block of the audio data represented by the bitstream; means for performing, based on the current indication and the previous indication, level estimation to obtain a level estimate indication representative of an estimate of the level of the current block of the audio data represented by the bitstream; and means for performing, based on the level estimate indication, decompression with respect to the current block of the audio data represented by the bitstream to obtain a decompressed version of the current block of the audio data.

Clause 22B. The sink device of clause 21B, further comprising means for obtaining a bit allocation identifying a number of bits allocated to a portion of the audio data represented by the bitstream that includes the current block, and wherein the current indication includes the bit allocation.

Clause 23B. The sink device of clause 22B, wherein the portion of the audio data includes a filtered portion of a plurality of filtered portions of the audio data.

Clause 24B. The sink device of clause 23B, wherein the plurality of filtered portions comprises a plurality of subbands.

Clause 25B. The sink device of any combination of clauses 21B-24B, wherein the means for performing the level estimation comprises: means for performing, based on the previous indication, the level estimation to obtain the level estimate indication; means for comparing, after obtaining the level estimate indication, the current indication to a threshold; and means for increasing, when the current indication is greater than or equal to the threshold, the level estimate indication.

Clause 26B. The sink device of any combination of clauses 21B-25B, wherein the level estimate indication comprises a quantization step size, and wherein the means for performing the compression comprises means for performing, based on the quantization step size, inverse quantization with respect to the current block of the audio data represented by the bitstream to obtain the decompressed version of the current block.

Clause 27B. The sink device of any combination of clauses 21B-26B, further comprising means for receiving the bitstream via a wireless connection in accordance with a wireless communication protocol.

Clause 28B. The sink device of clause 27B, wherein the wireless communication protocol comprises a personal area network wireless communication protocol.

Clause 29B. The sink device of clause 28B, wherein the personal area network wireless communication protocol comprises a Bluetooth® wireless communication protocol.

Clause 30B. The sink device of clause 28B, wherein the personal area network wireless communication protocol comprises a Bluetooth® wireless communication protocol operating according to the advance audio distribution profile.

Clause 31B. A non-transitory computer-readable storage medium having stored thereon instructions that, when executed, cause one or more processors of a sink device to: obtain, from a bitstream representative of audio data, a current indication representative of a current level of a current block of the audio data represented by the bitstream; obtain a previous indication representative of a previous level of a previous block of the audio data represented by the bitstream; perform, based on the current indication and the previous indication, level estimation to obtain a level estimate indication representative of an estimate of the level of the current block of the audio data represented by the bitstream; and perform, based on the level estimate indication, decompression with respect to the current block of the audio data represented by the bitstream to obtain a decompressed version of the current block of the audio data.

Various aspects of the techniques have been described. These and other aspects of the techniques are within the scope of the following claims.

1. A source device configured to process audio data, the source device comprising:
a memory configured to store at least a portion of the audio data; and
one or more processors coupled to the memory, and configured to:
obtain a current indication representative of a current level of a current block of the audio data;
obtain a previous indication representative of a previous level of a previous block of the audio data;
perform, based on the current indication and the previous indication, level estimation to obtain a level estimate indication representative of an estimate of the level of the current block of the audio data; and
perform, based on the level estimate indication, compression with respect to the current block of the audio data to obtain a bitstream.

2. The source device of claim 1,
wherein the one or more processors are further configured to perform bit allocation with respect to a portion of the audio data that includes the current block to obtain a bit allocation identifying a number of bits allocated to the portion of the audio data that includes the current block, and
wherein the current indication includes the bit allocation.

3. The source device of claim 1,
wherein the one or more processors are further configured to:
apply a filter to the audio data to obtain a plurality of filtered portions of audio data, and
perform bit allocation with respect to one of the plurality of filtered portions of the audio data that includes the current block to obtain a bit allocation identifying a number of bits allocated to the one of the plurality of filtered portions of the audio data that includes the current block,
wherein the current indication includes the bit allocation.

4. The source device of claim 3,
wherein the filter comprises a subband filter, and
wherein the plurality of filtered portions comprises a plurality of subbands.

5. The source device of claim 1, wherein the one or more processors are configured to:
perform, based on the previous indication, level estimation to obtain the level estimate indication;
compare, after obtaining the level estimate indication, the current indication to a threshold; and
increase, when the current indication is greater than or equal to the threshold, the level estimate indication.

6. The source device of claim 1,
wherein the level estimate indication comprises a quantization step size, and
wherein the one or more processors are configured to perform, based on the quantization step size, quantization with respect to the current block to obtain the bitstream.

7. The source device of claim 1, further comprising a transceiver configured to transmit the bitstream to a sink device in accordance with a wireless communication protocol.

8. The source device of claim 7, wherein the wireless communication protocol comprises a personal area network wireless communication protocol.

9. The source device of claim 7, wherein the personal area network wireless communication protocol comprises a Bluetooth® wireless communication protocol.

10. The source device of claim 7, wherein the personal area network wireless communication protocol comprises a Bluetooth® wireless communication protocol operating according to the advance audio distribution profile.

11. A method of processing audio data, the method comprising:
obtaining a current indication representative of a current level of a current block of the audio data;
obtaining a previous indication representative of a previous level of a previous block of the audio data;
performing, based on the current indication and the previous indication, level estimation to obtain a level estimate indication representative of an estimate of the level of the current block of the audio data; and
performing, based on the level estimate indication, compression with respect to the current block of the audio data to obtain a bitstream.

12. The method of claim 11, further comprising performing bit allocation with respect to a portion of the audio data that includes the current block to obtain a bit allocation identifying a number of bits allocated to the portion of the audio data that includes the current block,
wherein the current indication includes the bit allocation.

13. The method of claim 11, further comprising:
applying a filter to the audio data to obtain a plurality of filtered portions of audio data, and
performing bit allocation with respect to one of the plurality of filtered portions of the audio data that includes the current block to obtain a bit allocation identifying a number of bits allocated to the one of the plurality of filtered portions of the audio data that includes the current block,
wherein the current indication includes the bit allocation.

14. The method of claim 13,
wherein the filter comprises a subband filter, and
wherein the plurality of filtered portions comprises a plurality of subbands.

15. The method of claim 11, wherein performing the level estimation comprises:
performing, based on the previous indication, the level estimation to obtain the level estimate indication;
comparing, after obtaining the level estimate indication, the current indication to a threshold; and
increasing, when the current indication is greater than or equal to the threshold, the level estimate indication.

16. The method of claim 11,
wherein the level estimate indication comprises a quantization step size, and
wherein performing the compression comprises performing, based on the quantization step size, quantization with respect to the current block to obtain the bitstream.

17. The method of claim 11, further comprising transmitting the bitstream to a sink device in accordance with a wireless communication protocol.

18. A sink device configured to process a bitstream representative of audio data, the sink device comprising:
a memory configured to store at least a portion of the bitstream; and
one or more processors coupled to the memory, and configured to:
obtain, from the bitstream, a current indication representative of a current level of a current block of the audio data represented by the bitstream;
obtain a previous indication representative of a previous level of a previous block of the audio data represented by the bitstream;
perform, based on the current indication and the previous indication, level estimation to obtain a level estimate indication representative of an estimate of the level of the current block of the audio data represented by the bitstream; and
perform, based on the level estimate indication, decompression with respect to the current block of the audio data represented by the bitstream to obtain a decompressed version of the current block of the audio data.

19. The sink device of claim 18,
wherein the one or more processors are further configured to obtain a bit allocation identifying a number of bits allocated to a portion of the audio data represented by the bitstream that includes the current block, and
wherein the current indication includes the bit allocation.

20. The sink device of claim 19, wherein the portion of the audio data includes a filtered portion of a plurality of filtered portions of the audio data.

21. The sink device of claim 20, wherein the plurality of filtered portions comprises a plurality of subbands.

22. The sink device of claim 18, wherein the one or more processors are configured to:
perform, based on the previous indication, level estimation to obtain the level estimate indication;
compare, after obtaining the level estimate indication, the current indication to a threshold; and
increase, when the current indication is greater than or equal to the threshold, the level estimate indication.

23. The sink device of claim 18,
wherein the level estimate indication comprises a quantization step size, and
wherein the one or more processors are configured to perform, based on the quantization step size, inverse quantization with respect to the current block of the audio data represented by the bitstream to obtain the decompressed version of the current block.

24. The sink device of claim 18, further comprising a transceiver configured to receive the bitstream via a wireless connection in accordance with a wireless communication protocol.

25. A method of processing a bitstream representative of audio data, the method comprising:
obtaining, from the bitstream, a current indication representative of a current level of a current block of the audio data represented by the bitstream;
obtaining a previous indication representative of a previous level of a previous block of the audio data represented by the bitstream;
performing, based on the current indication and the previous indication, level estimation to obtain a level estimate indication representative of an estimate of the level of the current block of the audio data represented by the bitstream; and
performing, based on the level estimate indication, decompression with respect to the current block of the audio data represented by the bitstream to obtain a decompressed version of the current block of the audio data.

26. The method of claim 25, further comprising obtaining a bit allocation identifying a number of bits allocated to a portion of the audio data represented by the bitstream that includes the current block, and
wherein the current indication includes the bit allocation.

27. The method of claim 26, wherein the portion of the audio data includes a filtered portion of a plurality of filtered portions of the audio data.

28. The method of claim 27, wherein the plurality of filtered portions comprises a plurality of subbands.

29. The method of claim 25, wherein performing the level estimation comprises:
performing, based on the previous indication, the level estimation to obtain the level estimate indication;
comparing, after obtaining the level estimate indication, the current indication to a threshold; and
increasing, when the current indication is greater than or equal to the threshold, the level estimate indication.

30. The method of claim 25,
wherein the level estimate indication comprises a quantization step size, and
wherein performing the compression comprises performing, based on the quantization step size, inverse quantization with respect to the current block of the audio data represented by the bitstream to obtain the decompressed version of the current block.
